(19) United States
(12) Patent Application Publication
(10) Pub. No.: US 2007/0003913 A1
(43) Pub. Date: Jan. 4, 2007

(54) EDUCATIONAL VERBO-VISUALIZER INTERFACE SYSTEM

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/535,430

(22) Filed: Sep. 26, 2006

Related U.S. Application Data
(60) Provisional application No. 60/728,835, filed on Oct. 22, 2005.

(51) Int. Cl. G09B 19/00

(52) U.S. Cl. 434/156

(57) ABSTRACT

A computer-based educational tool is provided to enable children to more easily learn the visual representations of letters, numbers, shapes, colors, and words, by drawing upon their existing verbal knowledge. More specifically, a child is allowed to utter the name of a letter, number, shape, color, or word and have the corresponding visual representation of that letter, number, shape, color, or word be displayed visually upon a screen in response to his or her verbal utterance. Speech recognition tools and techniques are utilized for capturing and recognizing the verbal utterances of the child. Unique visual and aural display methods is utilized for presenting content to the child in developmentally beneficial ways.

### RELATED APPLICATION DATA

This application claims priority to provisional application Ser. No. 60/728,835, filed Oct. 22, 2005, the disclosure of which is hereby incorporated by reference.

### FIELD OF THE APPLICATION

The present invention relates generally to a verbo-visualizer interface system and more particularly to a system, and associated method, for receiving an audible input from a user and presenting a visual representation of the audible input on a display.

### BACKGROUND

It is well known among early childhood educators that young children must be exposed to abundant opportunities through which written textual expressions are associated with corresponding verbal utterances. It is through such associations that young kids develop the requisite mental pathways by which to recognize letters, numbers, words, punctuation, and other visually displayed symbols. For example, young children must memorize through repeated exposure that the visual representation 12 corresponds with the verbal utterance twelve. Similarly they must learn that the visual representations “G” and “g” corresponds with the verbal utterance “gee.” It is in preschool and kindergarten that children develop the basic associations for letters and numbers. Once children have mastered this foundation they begin learning to recognize full words. During the early stages, reading is a process of sounding-out words phonetically but ultimately children must develop mental pathways by which textually represented words are recognized from memory holistically and are associated with their corresponding verbal form. Thus a central part of learning to read is the rote memorization of visually represented symbols.

A current problem with the educational tools and methods by which young children learn to recognize, letters, numbers, words, punctuation, symbols and other visual representations such as shapes and colors, is that the associations to which they are exposed almost exclusively involve being shown the visual representation and then being told the corresponding verbal utterance. For example, kids are shown flash cards of letters and numbers and then are told what the verbal representation is. Similarly adults read to kids from books, and the visual representations are pointed at by the adults as the corresponding words are read aloud as verbal utterances. There are very few experiences that children have in which a verbal utterance is presented first and the visual representation follows. This is problematic because children, by virtual of their natural mental development processes, learn to speak the names of letters, the names of numbers, and a large vocabulary of words, long before they learn to recognize them visually. Very few educational techniques allow students to draw upon their existing verbal knowledge as the impetus for learning corresponding visual representations. For example, a child of three or four years old likely knows how to say the word twelve but does not know how to recognize that word visually. The child may be curious what that number twelve looks like but there are no existing educational tools and very few educational opportunities by which a child can act on this curiosity. At the present time, the only method by which a child can act on his or her curiosity about the visual representation of a letter, number, word, shape, or color that he or she knows verbally is to ask an adult to show him or her what that visual representation looks like. For example, the child in the forgoing example might ask his parent or teacher to tell him what the symbol for twelve looks like.

The central problem with the current educational methods by which young children learn to memorize the visual representations of letters, number, words, symbols, shapes, and colors is that almost without exception, the current methods are directed and controlled by an adult, a television, or a piece of automated software and not by the curiosity of the child himself or herself. There are some pieces of software that exist that allow some child directed learning, but these exclusively involve a child selecting an unknown visual symbol and having the computer produce the corresponding verbal utterance. For example, a piece of computer software may present a child with a listing of all the letters A through Z. The child may select a letter by clicking on it with a mouse and in response have the computer produce the corresponding verbal utterance. In this way the child may take some control over his learning process and explore letters that he or she is curious about. Such learning tools are helpful, but again they exclusively follow the sequence of showing a child a symbol first and then telling the child to which verbal utterance it corresponds. Children already have an excess of such experiences in school and at home. What children need is more experiences by which they can draw upon their existing verbal knowledge and inquire based upon their own curiosity what the corresponding visual representation is.

### SUMMARY

A computer moderated educational tool is disclosed that enables young children to express themselves verbally and be immediately presented with a clear and distinct visual representation of their verbal utterance. The present invention is directed at helping young kids learn their letters, numbers, shapes and colors by drawing upon their preexisting verbal knowledge. Some embodiments of the present invention are also directed at helping young kids learn textual words by drawing upon their preexisting verbal knowledge. A verbal utterance of a child is captured and processed. In response to the child issuing one of a plurality of select verbal utterances, a corresponding visual image is presented to the child in a visually prominent and thereby unambiguous form, the visual image being displayed in close time-proximity to the child's issuance of the verbal utterance. In this way the child may more easily learn the direct relational association between the each one of a set of select verbal utterances and each one of a set of corresponding visual representations. A child may use this technology, for example, to learn his or her letters, colors, numbers, shapes, and basic words.

At least one embodiment of the present invention is directed to an educational verbal-visualization system. A microphone captures verbal utterances from a user. A display displays visual images to the user. A speaker plays verbal articulations to the user. A memory stores the visual images and the verbal articulations. A processor is in communication with the microphone, display, memory, and speaker. The processor performs verbal-visualization routines comprising: (a) analyzing the captured verbal utterances from the user; (b) determining whether one of a plurality of select verbal utterances has been issued by the user and, in response to a successful determination, identifying a particular select verbal utterance issued; (c) selecting from the memory a stored visual image that relationally corresponds with the identified particular select verbal utterance; (d) causing a prominent display of the stored visual image to the user within a close time proximity of issuance of the particular select verbal utterance; and (e) accessing from the memory a stored verbal articulation that mimics the particular select verbal utterance and causing the stored verbal articulation to be played through the speaker a short time delay after the issuance of the particular select verbal utterance, the short time delay being selected such that the played verbal articulation presents an echo effect of the select verbal utterance of the user.

At least one embodiment of the invention is directed to a method for educational verbal-visualization. An electronically captured verbal utterance from a user is analyzed. A determination of whether the captured verbal utterance corresponds to one of a plurality of select verbal utterances is made and, in response to a successful determination, a particular select verbal utterance issued by the user is identified. A stored visual image relationally corresponding to the identified particular select verbal utterance is selected from a memory. A prominent visual presentation of the selected visual image is caused to be displayed upon an electronic display. The prominent visual presentation is imparted within a close time proximity of issuance of the particular select verbal utterance by the user. A stored verbal articulation that mimics the particular select verbal utterance is accessed from the memory. The stored verbal articulation is caused to be played through the speaker a short time delay after the issuance of the particular select verbal utterance. The short time delay is selected such that the played verbal articulation presents an echo effect of the select verbal utterance of the user.

At least one embodiment of the invention is directed to a method for educational verbal-visualization. A set of select verbal utterances is defined in a computer memory. The set of select verbal utterances comprises names of letters in an alphabet, names of numbers, names of shapes, and the names of colors. An electronically captured verbal utterance from a user is analyzed. A determination is made regarding whether the captured verbal utterance corresponds to one of the set of select verbal defined in the computer memory. In response to a successful determining, a particular one of the select verbal utterances that was issued by the user is identified. A stored visual image that relationally corresponds to the identified particular one of the select verbal utterances is selected from the memory. The stored visual image depicts at least one of a textual letter, textual number, graphical shape, and graphical color that directly corresponds to the identified particular select verbal utterance. A prominent visual presentation of the selected visual image is caused to be displayed upon an electronic display. The prominent visual presentation is imparted within a close time proximity of issuance of the particular select verbal utterance by the user.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a system architecture according to at least one embodiment of the invention;

FIG. 2A illustrates a sample blank screen displayed upon the visual display according to at least one embodiment of the invention;

FIG. 2B illustrates the letter “A” displayed prominently upon the all white field background image upon the visual display according to at least one embodiment of the invention;

FIGS. 3A-3C illustrate different example display screens produced by the letter-teaching and number-teaching methods and apparatus according to at least one embodiment of the present invention;

FIGS. 4A-4C illustrates display screens showing shape-teaching methods according to at least one embodiment of the invention;

FIGS. 5A and 5B illustrate example display screens produced by the color-teaching methods and apparatus according to at least one embodiment of the invention;

FIG. 6 illustrates a sample display screen produced by a number-teaching method according to at least one embodiment of the invention;

FIGS. 7A and 7B illustrate sample display screens produced by a letter-teaching method according to at least one embodiment of the invention; and

FIGS. 8A-8C illustrate sample display screens produced by Augmented Digital Mirror embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention are directed to a computer-based educational tool that enables children to learn the visual representations of letters, numbers, shapes, colors, and words, by drawing upon their existing verbal knowledge. For example, embodiments of the present invention allow a child to utter the name of a letter, number, shape, or color, and have the corresponding visual representation of that letter, number, shape, or color be displayed visually upon a screen in response to his or her verbal utterance. Embodiments of the current invention use speech recognition tools and techniques for capturing and recognizing the verbal utterances of the child. Unique visual display routines are utilized for displaying visual symbols to the child users in educationally beneficial ways. For example, in response to a verbal utterance, as processed by speech recognition tools and techniques, the corresponding letters, number, shapes, colors, and/or words are displayed in a unique visual format that enables children to associate their most recent verbal utterance with the displayed visual symbol. More specifically, embodiments of the present invention allow a child to utter the name of a letter, number, shape, or color, and have a corresponding visual representation of that letter, number, shape, or color be displayed in a visually prominent manner and in close time-proximity to the verbal utterance such that the child is provided with an unambiguous verbo-visual association between his or her most recent verbal utterance and the currently displayed visual representation. Embodiments of the present invention also include advanced inventive features including graphical number-line display embodiments, alphabet display embodiments, audio echo embodiments, and augmented digital mirror embodiment that provide additional educational benefits.

Embodiments of the present invention provide a solution to the existing limitations of educational tools, methods, and technologies for helping kids learn to recognize letters, numbers, words, and symbols. Such embodiments are directed at freeing children from being passive participants in the symbol association processes, allowing them to draw upon their existing verbal knowledge and inquire about corresponding symbols in a self directed way. Embodiments of the present invention are also directed at addressing the fact that most association experiences that children are exposed to in classrooms today begin with the symbol first and then follow by presenting the verbal utterance. Embodiments of the present invention solve these problems by employing voice recognition hardware and software, an education specific database that associates verbal utterances with visual symbols, and visual display tools, to enable children to draw upon their existing verbal knowledge and inquire about corresponding visual symbols in a self-directed educational experience

Referred to herein as a “VERBAL-VISUALIZER,” an embodiment of the present invention is a computer moderated educational tool that enables young children to express themselves verbally and be immediately presented with a clear and distinct visual representation of their verbal utterance. Unlike dictation software produced for adults that stream a sequence of words in a text format without clear time-synchronization between each specific word uttered and each particular visual representation, embodiments of the present invention include inventive display features that enable children to make a clear association between each of their verbal utterances and the corresponding visual representation. In addition, special features and modes are utilized for supporting children who are in different stages of learning. For example, some embodiments of the verbal-visualizer technology are directed exclusively at letter-teaching experiences. Other embodiments are directed at number-teaching experiences. Additional embodiments are directed at experiences involving colors and/or shapes. Finally, some embodiments of the present invention enable child-directed visualizing of whole words based upon their verbal utterances.

With respect to embodiments of the present invention directed at supporting enhanced letter-teaching experiences for children, the computer interface technology is configured to allow children to speak the name of a letter and have that letter displayed distinctly and unambiguously upon a screen, thereby enabling a verbal-visual association initiated by the will of the child and drawing upon the child's existing verbal knowledge. This is achieved by using speech recognition routines running on a computer processor, the speech recognition routines determine the letter spoken by the child. This is also achieved by specialized graphic display routines, the specialized graphic display routines being operative to present the letter to the child with time-synchronization and display characteristics such that it is clear to the child that the currently displayed letter corresponds with the particular verbal utterance he or she just produced. This is achieved by having a minimized time-delay between the time the child spoke the name of the letter and the time when the corresponding letter is produced. For example, the time delay is less than 1000 milliseconds. In addition the display characteristics of the letter are such that letter most recently spoken by the child is prominently displayed upon the screen with respect to all else that happens to also be displayed upon the screen. For example, the letter may be produced larger, brighter, and/or in a more central location than other information currently upon the display. In some embodiments the letter may be displayed alone as the only visual object presented to the user at that moment in time to avoid ambiguity. In some embodiments the letter may be animated to further draw visual attention to it, including flashing, pulsing, and/or changes in size and/or shape. Furthermore the prominent display characteristics of the letter last for a period of time that is long enough for the child to make the verbo-visual association between the verbal utterance of the letter and the visual display of the letter. In some embodiments long enough is determined to be at least four seconds.

In some embodiments of the letter-teaching technology, children are enabled to selectively utter the sound that a letter makes and have that letter be displayed distinctly and unambiguously upon a screen. For example the child may utter the sound that a letter “t” makes rather than the name of the letter “t.” The speech recognition routines are configured to recognize the phonic sound of the letter t and/or the name of the letter t and in either instances will display the letter “t” prominently upon the screen within a sufficient time-synchronization and visual prominence such that the child can easily make the association between his or her verbal utterance and the particularly displayed letter. In some embodiments of the letter-teaching technology, both upper and lower case representations of the letter are displayed to the child upon a single utterance. For example, the child utters the name of the letter G and upon recognition by the speech recognition routines, the upper case letter G and the lower case letter g are both visually displayed to the child. In generally they are displayed with sufficient spatial and/or temporal separation such that the child is made to understand that each is a distinct letter and not a letter combination. In some embodiments of the letter-teaching technology, children may selectively specify upper-case or lower-case, uttering for example “lower-case gee” or “little gee” and be presented with a graphical display of the lower case letter g in a distinct and unambiguous visual association with the initiating utterance.

In some embodiments of the letter-teaching technology, children are presented with the visual representation of the letter along with an audio representation of the verbal utterance of the letter. For example the child says “gee” and is presented with a visual representation of the letter “g.” After a short pause a sound is displayed by the computer that repeats the verbal word “gee” for reinforcement. In some embodiments the sound that is displayed is a digitized representation of the child's own voice uttering the word. In this way the child hears his own verbal utterance played back to him or her. This is a particularly engaging embodiment for young children because they are generally interested in recordings of their own voice. Such embodiments, referred to herein as “echo embodiments” allow a child to speak a letter to the computer interface. The computer interface uses speech recognition routines to identify the letter uttered by the child. That letter is then displayed to the child with time-synchronization and/or verbal prominence that makes it clear that the letter being presented corresponds to his or her most recent verbal utterance. When the letter is displayed, in optional time-synchronization, the system also plays a computer generated voice or digitized recording of the child's own voice uttering the letter. In this way the child says the letter and is quickly presented with a visual representation of the letter along with a verbal utterance of the name of the letter that to the child sounds like an echo of his or her own utterance. This echo embodiment is particularly engaging for young children because the computer seems to be mimicking his or her own actions. Children find it very amusing to experiment with letters in such an interface scenario. In some embodiments of the letter-teaching technology, children may to utter phonic combinations of letters and have those combinations displayed as described above. In such embodiments the speech recognition algorithms are configured to recognize double letter combinations, such as the sound made by “th” or “sh” or “ch” wherein each letters sound is not individually distinguishable. In this way a child may utter the sound that that “th” makes and be presented with the textual representation of the “th” letter combination alone or with a audio echo of the sound as described above.

The display may be configured such that a complete alphabet is presented to the user, the alphabet including all the letters A through Z. Referred to herein as an “Alphabet Embodiment” of the present invention, when a user utters the name and/or sound of a particular letter, that letter in the displayed alphabet is caused by the visual display routines of the current invention to become more prominently displayed than the other letters in the alphabet. For example, an uttered letter (by name or by sound) is caused to be displayed larger, more brightly rendered, and/or differently colored than the other letters in the alphabet display. For example, using an Alphabet Embodiment of the present invention, a child might speak the letter “P” to the microphone input of the system. The speech recognition algorithms of embodiments of the present invention process the input sound stream and determine that the child spoke the name of the letter “p.” Graphical output routines subsequently modify the display of a complete alphabet being shown upon the screen such that the letter “P” in the alphabet is presented larger, brighter, in a bolder font, or otherwise more visually accentuated than the other letters presented.

With respect to the number-teaching embodiments of the present invention, the computer hardware and software is configured to allow children to speak the name of a number and have that number be displayed distinctly and unambiguously upon a screen, thereby enabling a verbal-visual association initiated by the will of the child and drawing upon the child's existing verbal knowledge. This is a particularly valuable educational tool because children almost always learn to say numbers before they learn to recognize them visually. Thus by using such embodiments of the present invention, a child can draw upon his or her existing verbal knowledge of numbers and request the corresponding visual representation at will. This is achieved by using speech recognition routines running on a computer processor, the speech recognition routines determine the number spoken by the child. This is also achieved by specialized graphic display routines, the specialized graphic display routines being operative to present the number to the child with time-synchronization and display characteristics such that it is clear to the child that the currently displayed number corresponds with the particular verbal utterance he or she just produced. This is best achieved by having a short time-delay between the time the child speaks the name of the number and the time when the corresponding textual representation of the number is produced. For example, the time delay is less than 1000 milliseconds in many embodiments of the present invention. Additionally, the display characteristics of the number are configured such that the number most recently spoken by the child is prominently displayed upon the screen with respect to other information that may then also displayed upon the screen. For example, the number may be produced larger, brighter, and/or in a more central location than other information currently upon the display. In some embodiments the number may be displayed alone as the only visual object presented to the user to avoid ambiguity. In some embodiments the number may be animated to further draw visual attention to it, including flashing, pulsing, and/or changes in size and/or shape. Furthermore the prominent display characteristics of the number are configured such that they last temporally for a period of time that is long enough for the child to make the verbo-visual association between the verbal utterance of the number and the visual display of the number. In some embodiments this “long enough” time interval is determined to be at least four seconds.

In some embodiments of the number-teaching technology, the display is configured such that a number line image is presented to the user, and the number line includes additional numbers that are presented in a less emphasized manner to provide context for the selected number. Referred to herein as a “Number Line Embodiment” with respect to some embodiments of the present invention, such a configuration is highly effective at informing the child as to the numeral representation of a spoken number AS WELL AS providing the child with context with which to relate that number to other numbers that the child might know. For example, using a Number Line Embodiment of the present invention, a child might speak the word “sixteen” to the microphone input of the system. The speech recognition algorithms process the input sound stream and determine that the child spoke the word “sixteen.” Graphical output routines then display a number-line to the child with the number 16 presented in a visually emphasized manner. For example, the number 16 is presented larger, brighter, in a bolder font, or otherwise more visually accentuated than the other numbers presented in the number line. Also, in many embodiments only a portion of the number line is presented, that portion centered around the verbally spoken number. For example in the instance cited above, the number 16 would appear at the center of a partial number line, surrounded by a few numbers on either side to provide context, those other numbers presented in a less visually accentuated manner than the number 16.

In some embodiments of the number-teaching technology, children are presented with the visual representation of the number along with an audio representation of the verbal utterance of the name of the number. For example, the child may say “four” and be presented with a visual representation of the number 4. After a short pause a sound is displayed by the computer that repeats the utterance “four” for reinforcement. In some embodiments the sound that is displayed is a digitized representation of the child's own voice uttering the word four. In this way the child hears his own verbal utterance played back to him or her. This is a particularly engaging embodiment for young children because they are generally interested in recordings of their own voice. Such embodiments, referred to herein as “echo embodiments” such that when the number is displayed or some short time afterwards, the system plays a computer generated voice or digitized recording of the child's own voice uttering the name of the number. In this way the child says the number and is quickly presented with a visual representation of the number along with an verbal utterance of the name of the number that to the child sounds like an echo.

With respect to the shape-teaching embodiments of the present invention, the hardware and software are configured to allow children to speak the name of a shape and have a graphical figurative representation of that shape displayed distinctly and unambiguously upon a screen, thereby enabling a verbal-visual association initiated by the will of the child and drawing upon the child's existing verbal knowledge. This is achieved by using speech recognition routines running on a computer processor, where the speech recognition routines determine the name of the shape spoken by the child. This is also achieved by specialized graphic display routines, the specialized graphic display routines being operative to present an iconic graphical figure of the shape to the child with time-synchronization and display characteristics such that it is clear to the child that the currently displayed graphical shape corresponds with the particular verbal utterance he or she just produced. This is achieved by having a minimal time-delay between the time the child spoke the name of the shape and the time when the corresponding shape is produced. For example, the time delay is less than 1000 milliseconds in many embodiments of the present invention. In addition the display characteristics of the shape are such that shape name most recently spoken by the child is prominently displayed upon the screen with respect to all else displayed upon the screen. For example, the shape is produced larger, brighter, and/or in a more central location than other information currently upon the display. In some embodiments the shape may be displayed alone as the only visual object presented to the user at that moment in time to avoid ambiguity. In some embodiments the shape may be animated to further draw visual attention to it, including moving, flashing, pulsing, and/or changing in size. Furthermore, the prominent display characteristics of the graphical shape last for a period of time that is long enough for the child to make the verbo-visual association between the verbal utterance of the shape name and the visual display of the graphical shape form. In some embodiments this “long enough” time interval is determined to be at least four seconds.

For example, a user of embodiments of the present invention may utter the word “square” into the microphone input of the hardware-software system. The speech recognition algorithms process the input sound stream and determine that the child spoke the word “square.” This word is associated in digital memory with the graphical shape of a square. Based upon this association, graphical output routines then display a graphical image to the child, the graphical image being the shape of a square. The square is presented larger, brighter, or otherwise more visually accentuated than the other items presented on the screen. In some embodiments the square is the only image presented upon an otherwise blank screen. In this way the child is enabled to easily make the verbo-visual association between the uttered word “square” and the graphically displayed square shape.

With respect to color-teaching embodiments of the present invention, the hardware and software is configured to allow children to speak the name of a color and have a graphical image representing that color be displayed distinctly and unambiguously upon a screen, thereby enabling a verbal-visual association initiated by the will of the child and drawing upon the child's existing verbal knowledge. This is achieved by using speech recognition routines running on a computer processor, and the speech recognition routines determine the name of the color spoken by the child. This is also achieved by specialized graphic display routines, the specialized graphic display routines being operative to present a graphical patch or area of the color name spoken by the child with time-synchronization and display characteristics such that it is clear to the child that the currently displayed graphical color corresponds with the particular verbal utterance he or she just produced. This is achieved by having a minimal time-delay between the time the child spoke the name of the color and the time when the corresponding color is produced. For example, the time delay is less than 1000 milliseconds in many embodiments of the present invention. In addition the display characteristics of the color are such that color name most recently spoken by the child is prominently displayed upon the screen with respect to all else displayed upon the screen. For example, the color area is displayed larger and/or in a more central location than other information currently upon the display. In some embodiments the colored area may be the only visual object presented to the user at that moment in time to avoid ambiguity. The prominent display characteristics of the graphical color area last for a period of time that is long enough for the child to make the verbo-visual association between the verbal utterance of the color name and the visual display of the graphical color. In some embodiments this “long enough” time interval is determined to be at least four seconds.

A user of an embodiment of the present invention may utter the word “green” into the microphone input of the hardware-software system. The speech recognition algorithms subsequently process the input sound stream and determine that the child spoke the word “green.” This word is associated in digital memory of the present invention to the graphical color green. Based upon this association, the graphical output routines then display a graphical image to the child, the graphical image being the a prominent area or object shaded in the color green. In some embodiments the green area is the only image presented upon an otherwise blank screen. In this way the child is enabled to easily make the verbo-visual association between the uttered word “green” and the graphically displayed green color.

With respect to the word-teaching embodiments of the present invention, the computer interface technology is configured to allow children to speak single words, one at a time, and have the word textually displayed distinctly and unambiguously upon a screen, thereby enabling a verbal-visual association initiated by the will of the child and drawing upon the child's existing verbal knowledge. In general the vocabulary of words supported by embodiments of the current invention includes words that are age appropriate for young children with a special emphasis on words that young children must learn to visually recognize such as the, are, he, she, is, his, her, we, our, and, yes, no, and here. This functionality is achieved by using speech recognition routines running on a computer processor; the speech recognition routines determine the word spoken by the child. This is also achieved by specialized graphic display routines, the specialized graphic display routines being operative to present a textual representation of the word to the child with time-synchronization and display characteristics such that it is clear to the child that the currently displayed word corresponds with the particular verbal utterance he or she just produced. This is achieved by having a minimized time-delay between the time the child spoke the word and the time when the corresponding textual word is produced on the screen. For example, the time delay is less than 1000 milliseconds. In addition the display characteristics of the word are such that word most recently spoken by the child is prominently displayed upon the screen with respect to all else also displayed. For example, the current word is produced larger, brighter, and/or in a more central location than other information currently upon the display. In some embodiments the word may be displayed alone as the only visual object presented to the user at that moment in time to avoid ambiguity. In some embodiments the word may be animated to further draw visual attention to it, including flashing, pulsing, and/or changes in size and/or shape. Furthermore the prominent display characteristics of the letter last for a period of time that is long enough for the child to make the verbo-visual association between the verbal utterance of the word and the visual display of the word. In some embodiments this “long enough” time interval is determined to be at least four seconds.

In some embodiments of the word-teaching technology, children are presented with the visual representation of the word along with an audio representation of the verbal utterance of the word. For example the child may say “she” and be presented with a visual representation of the word “SHE.” After a short pause a sound is displayed by the computer that repeats the verbal utterance of the “she” for reinforcement. In some embodiments of the present invention the sound that is displayed is a digitized representation of the child's own voice uttering the word. In this way the child hears his own verbal utterance played back to him or her. This is a particularly engaging embodiment for young children because they are generally interested in recordings of their own voice. Such embodiments, referred to herein as “echo embodiments” allow a child to speak a word to the computer interface. The computer interface uses speech recognition routines to identify the word uttered by the child. That word is then displayed to the child with time-synchronization and/or verbal prominence that makes it clear that the word being presented corresponds to his or her most recent verbal utterance. When the word is displayed, in optional time-synchronization, the system also plays a computer generated voice or digitized recording of the child's own voice uttering the word aloud. In this way the child says the word and is quickly presented with a visual representation of the word along with a verbal utterance of the word that to the child sounds like an echo of his or her own utterance. This echo embodiment is particularly engaging for young children because the computer seems to be mimicking his or her own actions. Children often find it very amusing to experiment with words in such an interface scenario.

With respect to the letter-teaching, number-teaching, color-teaching, shape-teaching, and word-teaching embodiments of the present invention as described above, some particular configurations support an augmented digital mirror function that is intended to enhance the interest level achieved among young children and further accentuates the correlation between the verbally spoken words and their corresponding visual representations. The augmented digital mirror function employs a digital camera pointed at that child or children who are using the system such that as the child or children view the display screen, their faces are being captured by the digital camera. The augmented digital mirror function then projects, in real-time (i.e., with minimal time delay) the video footage captured of the child's face upon the screen. In this way as the child looks at the display screen he or she sees himself or herself and is given the impression that he or she is looking in the mirror. The ability to see himself of herself on the screen increases the interactivity of the interface, attracting the attention of young children who often like to see themselves. The ability to see himself or herself also increases the educational benefit of the interface for it encourages the young children to concentrate upon the verbal utterances that they produce for they are given the ability to view their own faces as they utter the words. Furthermore, the augmented digital mirror function of the current invention employs a graphical overlay feature such that when a child speaks a letter, number, color, shape, or word, the visual display of that letter, number, color, shape, or word, is presented in a graphical “word balloon” that appears to come from the mouth of the child's mirror image. This is very compelling to young children because it emulates the look of a comic book. By overlaying a graphical balloon upon the real-time image of the child a short time delay after the child utters the particular letter, number, color, shape, or word, the augmented digital mirror embodiments provides a clear, compelling, and unambiguous means of associating specific verbally spoken words from a learner with a specific corresponding visual representation, thereby supporting the learning process. In some embodiments that employ the augmented digital mirror functionality, audio echo functionality (as described previously) is also employed. In such embodiments that support augmented digital mirror functionality and audio echo functionality, the graphical word balloon is presented to the user, overlaid upon his or her digital mirror image, at the same time or nearly the same time as a computer generated verbal utterance of the particular letter, number, color, shape, or word is played through speakers.

Embodiments of the present invention are directed at freeing children from being passive participants in their symbol-association learning processes, allowing them take draw upon their existing verbal knowledge and inquire about corresponding symbols in a self directed way. To provide such benefits, such embodiments of the present invention enable a learner to verbally utter the name of a letter or number and in response is presented with an unambiguous visual representation of that particular letter or number. Similarly, embodiments of the present invention enable a learner to verbally utter the name of a shape and be presented with an unambiguous visual representation of that particular shape. Embodiments of the present invention enable a learner to verbally utter the name of a color and be presented with an unambiguous visual representation of that particular color. Similarly, a learner is enabled to verbally utter a particular word from among a particular vocabulary of words and presented with an unambiguous visual textual representation of that particular word such that it is not confused temporally and/or spatially with other visually presented words. Embodiments of present invention also enable a learner to verbally utter the sound that a particular letter or pair of letters represents and in response be presented with an unambiguous visual representation of that particular letter or pair of letters. In this way the learner may draw upon his or her existing verbal knowledge and initiate at will, visual experiences, through which he or she may build mental associations between verbal representations of the names of letters, numbers, shapes, colors, and certain words, and corresponding textual and/or graphical representations of each.

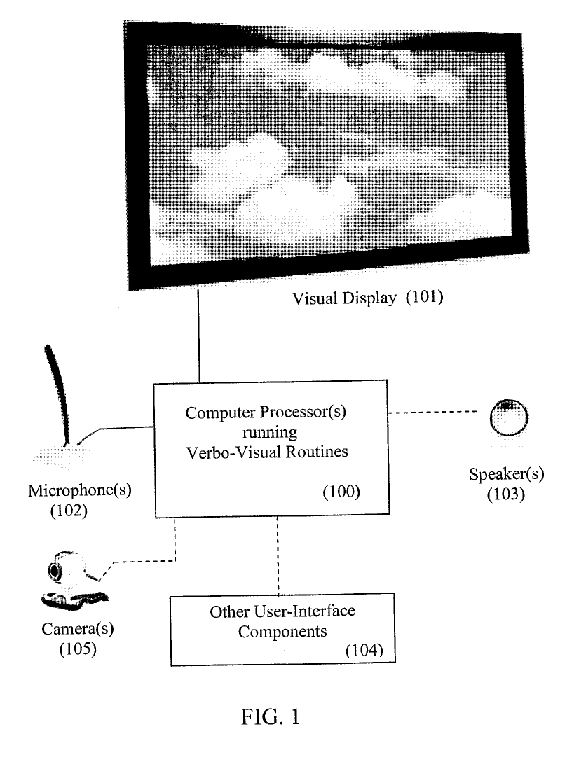

To achieve the above functionality, a system according to the present invention employs speech recognition hardware and software with a unique visual display methodology to allow learners, upon their own initiation, to express verbal utterances and in response be presented with a textual representation of corresponding letters, numbers, or words, and/or visual representations of corresponding shapes and/or colors. FIG. 1 illustrates a system architecture according to at least one embodiment of the invention. As shown, a computer processor 100 is employed to enable the verbo-visual functionality of the embodiment of present invention. The computer processor 100 may be a single processor or may be a plurality of processors working in combination. Software is configured to run on the processor 100 or processor to achieve the functionality discussed above. This software includes speech capture routines that are operative to receive verbal utterances of a user by detecting and storing sound signals from one or more microphones 102. This software includes speech recognition routines that are operative to identify the letters, numbers, shapes, colors, and/or words that are uttered by users of the present invention. This software also includes visual display routines that are operative to display the letters, numbers, shapes, colors, or words that are uttered by users and identified by the speech recognition routines. The visual display routines are unique and important, for they are operative to display each letter, number, shape, color, or word that is uttered by user and identified by the speech recognition routines in a visually unambiguous manner such that it is clear to the user that the particular displayed letter, number, shape, color, or word corresponds to his or her most recent verbal utterance. This is achieved by graphic display routines which are operative to visually present the identified letter, number, shape, color, or word to the child with time-synchronization characteristics and display characteristics such that it is apparent to the child that the currently displayed letter, number, shape, color, or word corresponds with the particular verbal utterance he or she most recently produced. This is enabled in some embodiments by having a minimized time-delay between the time the child spoke the name of the letter, number, color, shape, or word and the time when the corresponding letter, number, shape, color, or word is produced. In many such embodiments the time delay is maintained at less than 1000 milliseconds. In addition the display characteristics of the letter, number, shape, color, and/or word are such that letter, number, shape, color, or word most recently spoken by the child is prominently displayed upon the screen with respect to all else displayed upon the screen. For example, the currently identified letter, number, shape, color, or word is produced larger, brighter, and/or in a more central location than other information currently upon the display. In some embodiments the letter, number, shape, color, or word may be displayed alone as the only visual object presented to the user at that moment in time to avoid ambiguity. In some embodiments the letter, number, shape, color, or word may be animated to further draw visual attention to it, including flashing, pulsing, and/or changes in size and/or form. Furthermore, the prominent display characteristics lasts for a duration of time that is long enough for the child to make the verbo-visual association between the verbal utterance of the letter, number, shape, color, or word and the corresponding visual display. In many such embodiments the “long enough” time interval is determined to be at least four seconds.

Some embodiments of the present invention have additional functionality by which audio feedback is provided to users through one or more speakers 103 as shown in FIG. 1. More specifically, some embodiments of the present invention provide users an audio representation of the verbal utterance of the letter, number, color, shape, or word indicated by the user. For example the child says “square” and is presented with an unambiguous visual representation of a square using the methods and apparatus described above. After a short time-delay, a audio signal is displayed by the computer that repeats the verbal word “square,” providing additional verbo-visual association reinforcement. This is achieved through software routines running upon computer processor 100, the software routines including audio feedback software routines that selects and/or generates digital audio data that represents a verbal utterance corresponds with the selected letter, number, color, shape, or word. In the example above, digital audio data is selected and/or generated by the audio feedback software that corresponds with the verbal utterance “square”. In some embodiments of the present invention the digital audio data comprises a digitized representation of the child's own voice uttering the word. In other embodiments the digital audio file is a pre-stored digitized representation of some other real or artificial voice uttering the word. In additional embodiments the digital audio file is generated using speech synthesis software routines known to the art.

The digital audio file that represents a voice uttering the selected word is then played through the speakers 103 of the present invention. In this way the child hears a verbal utterance played to him or her of the name of the selected letter, number, shape, color, or word. To the child this sounds like an echo that mimics the utterance that he or she just recently produced. For example, the child utters the word “square.” The speech recognition system recognizes the word square and in response triggers the Visual Display Routines to display a visual square upon the screen. At the same time (or nearly the same time) as the square is displayed to the user, the audio feedback software selects and/or generates digital audio data that corresponds with the word “square.” This data is played such that the utterance “square” is generated through the speakers. In this way the child hears the word “square” at the same time, or nearly the same time, that the visual square is displayed to the user. This provides a rich learning experience for the child to support verbo-visual associations. In this example the child again says the word “square.” This triggers a square to be displayed upon the screen and an audio representation of the word “square” to be played. To the child the audio sound may seem like an echo of his or her own voice because it is the same word and it follows his or her own utterance after a short time delay. Because of this such embodiments are referred to herein as “echo embodiments.” As used herein, a sound event and a visual event happen at nearly the same time when the time delay between them is short enough that events seem temporally related to the user. In many embodiments nearly the same time means a time delay between events that is less than 2000 milliseconds.

Thus, echo embodiments of the present invention allow a child to speak a letter, number, color, shape, or word to the computer interface. The computer interface uses speech recognition routines to identify the letter, number, shape, color, or word uttered by the child. That letter, number, shape, color, or word is then displayed visually to the child with timing and/or verbal prominence that makes it clear to the user that the letter, number, shape, color, or word being presented corresponds to his or her most recent verbal utterance. At the same time (or nearly the same time) as the letter, number, shape, color, or word is displayed, the system also plays a computer generated voice or digitized recording of the child's own voice uttering the name of the letter, number, shape, color, or word. In this way the child says the letter and is quickly presented with a visual representation of the letter along with a verbal utterance of the name of the letter that to the child sounds like an echo of his or her own utterance. Echo embodiments are particularly engaging for young children because the computer seems to be mimicking his or her own actions.

Some embodiments of the present invention have additional functionality by which a digital mirror is enabled upon a display screen 101 such that the user can see his or her own image displayed upon the display. This is achieved through an augmented digital mirror function that is intended to enhance the interest of young children and provide additional correlation between the verbally spoken words and their corresponding visual representations. The augmented digital mirror function employs a digital camera 105 connected to processor 100 and pointed at that child who is using the system. The orientation of the camera is such that as the child views the display screen 101, their faces are captured by the digital camera. The augmented digital mirror function is then enabled by digital mirror display software running upon processor 100. The digital mirror display software is operative to capture the child's image from camera 105 and project that image, in real-time (i.e., with minimal time delay) upon the display screen 101. In this way as the child looks at the display screen he or she sees himself or herself and is given the impression that he or she is looking in a mirror. The ability to see himself of herself on the screen increases the interactivity of the interface, attracting the attention of young children who often like to see themselves. The ability to see himself or herself also increases the educational benefit of the interface for it encourages the young children to concentrate upon their own verbal utterances for they are given the ability to view their own faces as they utter the words.

In some embodiments of the present invention, the augmented digital mirror function of employs a graphical overlay feature such that when a child speaks a letter, number, color, shape, or word, the visual display of that letter, number, color, shape, or word, is presented in a graphical “word balloon” that appears to come from the mouth of the child's mirror image. This is very compelling to young children because it emulates the look of a comic book. By overlaying a graphical balloon upon the real-time image of the child's own face in time proximity of the child's own utterance of the particular letter, number, color, shape, or word, the augmented digital mirror embodiments provides a clear, compelling, and unambiguous means of associating specific verbally spoken words with a specific visual representation, thereby supporting the learning process. In some embodiments that employ the augmented digital mirror functionality, audio echo functionality (as described previously) is also employed. In such embodiments that support augmented digital mirror functionality and audio echo functionality, the graphical word balloon is presented to the user, overlaid upon his or her digital mirror image, and at the same time (or nearly the same time) a computer generated verbal utterance of the particularly displayed letter, number, color, shape, or word is presented as an audio signal to the user through speakers 103. The speakers 103 may be speakers, headphones, or other sound generating hardware. Additional user interface components can be included in the system and interfaced with the processor 100 such as buttons, keyboards, mice, hand controllers, foot pedals and the like. These user interface tools can provide supplemental input from the user or users for selecting modes, features, or functions of the present invention. For example, a mouse and graphical user interface may be provided to allow the user, or an associated adult, to select between or among letter-teaching, number-teaching, color-teaching, shape-teaching, or word-teaching modes of the present invention. Similarly, a mouse and graphical user interface may be provided to allow the user, or an associated adult, to enable or disable audio echo features, augmented digital mirror features, number-line display features, alphabet display features, and/or other display features or characteristics of the present invention as described herein. Such user interface tools are shown as element 104 in FIG. 1.

With respect to the software running upon computer processor 100, speech recognition routines are employed to recognize the verbal utterances of the child or children who are using the system. In general voice recognition systems are limited in the speed and accuracy because of the high variability of user utterances from person to person, because of potential noise in the environment of the user(s), and/or because single individual does not produce the same word exactly the same way every time. Recent advances in speech recognition technology have reduced these problems. In addition, increases in processing speeds of computing hardware have also reduced these problems. Embodiments of the present invention have particular design characteristics that further reduce the problems associated with speech recognition. For example, because the embodiments of the current invention have certain modes of operation in which children only speak the names of letters, numbers, shapes, and/or colors to the interface, the speech recognition routines need only identify utterances from among a relatively small vocabulary of utterances. This greatly simplifies the speech recognition process as compared to general purpose speech recognition routines used in dictation and other applications, for such general purpose speech recognition systems must recognize words from among a complete language dictionary of possible words, phrases, varying parts of speech, and varying conjugations. In addition to having a relatively small vocabulary of words, embodiments of the current invention may also employ a method by which only single words are spoken and recognized at a time, for example the name or sound of a letter, the name of a number, the name of a shape, or the name of a color. In this way, the speech recognition algorithms have a much smaller burden than a general purpose dictation system in which words from among a much larger vocabulary must be recognized in rapid sequence with user utterances often merging together such that the end of one word's utterance runs into the beginning of a next word's utterance. It is for these reasons that embodiments of the present invention can employ speech recognition techniques and achieves a high degree of recognition accuracy with small time delays, even within noisy environments and/or among a wide range of users and/or without extensive calibration or training sessions.

With respect to the specific methods and algorithms used to recognize the names of particular letters, numbers, colors, shapes, and/or words by processing the verbal utterances of one or more users, embodiments of the present invention may employ a variety of different techniques known to those skilled in the art. In general such techniques capture a user's voice through a microphone, digitize the audio signal to a computer readable form, process the digitized signal, and thereby identify the specific sounds, letters, words and/or phrases uttered by the user. One example of such a speech recognition system is disclosed in U.S. Pat. No. 6,804,643, the disclosure of which is hereby incorporated by reference. As disclosed in this patent, prior-art speech recognition systems consist of two main parts: a feature extraction (or front-end) stage and a pattern matching (or back-end) stage. The front-end effectively extracts speech parameters (typically referred to as features) relevant for recognition of a speech signal. The back-end receives these features and performs the actual recognition. In addition to reducing the amount of redundancy of the speech signal, it is also very important for the front-end to mitigate the effect of environmental factors, such as noise and/or factors specific to the terminal and acoustic environment.

The task of the feature extraction front-end is to convert a real time speech signal into a parametric representation in such a way that the most important information is extracted from the speech signal. The back-end is typically based on a Hidden Markov Model (HMM), a statistical model that adapts to speech in such a way that the probable words or phonemes are recognized from a set of parameters corresponding to distinct states of speech. The speech features provide these parameters.

It is possible to distribute the speech recognition operation so that the front-end and the back-end are separate from each other, for example the front-end may reside in a mobile device held by a user and the back-end may be elsewhere and connected to a communication network. Similarly the front end may be in a computer local to the user and the back-end may be elsewhere and connected by a network, for example by the internet, to said local computer. Naturally, speech features extracted by a front-end can be used in a device comprising both the front-end and the back-end. The objective is that the extracted feature vectors are robust to distortions caused by background noise, non-ideal equipment used to capture the speech signal and a communications channel if distributed speech recognition is used.

Speech recognition of a captured speech signal typically begins with analog-to-digital-conversion, pre-emphasis and segmentation of a time-domain electrical speech signal. Pre-emphasis emphasizes the amplitude of the speech signal at such frequencies in which the amplitude is usually smaller. Segmentation segments the signal into frames, each representing a short time period, usually 20 to 30 milliseconds. The frames are either temporally overlapping or non-overlapping. The speech features are generated using these frames, often in the form of Mel-Frequency Cepstral Coefficients (“MFCCs”).

MFCCs may provide good speech recognition accuracy in situations where there is little or no background noise, but performance drops significantly in the presence of only moderate levels of noise. Several techniques exist to improve the noise robustness of speech recognition front-ends that employ the MFCC approach. So-called cepstral domain parameter normalization (CN) is one of the most effective techniques known to date. Methods falling into this class attempt to normalize the extracted features in such a way that certain desirable statistical properties in the cepstral domain are achieved over the entire input utterance, for example zero mean, or zero mean and unity variance.

Some embodiments of the present invention referred to herein as “echo embodiments,” provide a visual display of the numbers, letter, shapes, and/or colors spoken by a user, and also play an audio representation of the name of the letter, shape, number, or color. For example, in an “echo embodiment” a child may speak the name of a letter to the computer interface and the computer interface uses speech recognition routines to identify the letter uttered by the child. That letter is then displayed to the child with time-synchronization and/or verbal prominence that makes it clear that the letter being presented corresponds to his or her most recent verbal utterance. The system also plays an audio signal that is either a computer generated voice or a digitized voice or a digital recording of the child's own voice uttering the name of that particular letter. In this way the child says the letter and is quickly presented with a visual representation of the letter along with a verbal utterance of the name of the letter that to the child sounds like an echo. This echo embodiment is particularly engaging for young children because the computer seems to be mimicking his or her own actions.

In order to enable the computer provided verbal utterance as described above, the system of the present invention is able to either capture and record the child's own voice and play it back. Alternatively, the system of the present invention may be able to generate discernable spoken language through speech synthesis methods. Many prior art technologies exist for synthesizing audible spoken language signals from a computer interface based upon a text script or other symbolic representation of the language. For example, U.S. Pat. No. 6,760,703, the disclosure of which is hereby incorporated by reference, discloses methods and an apparatus for performing speech synthesis from a computer interface. As disclosed in that patent, a method of artificially generating a speech signal from a text representation is called “text-to-speech synthesis.” The text-to-speech synthesis is generally carried out in three stages comprising a speech processor, a phoneme processor and a speech synthesis section. An input text is first subjected to morphological analysis and syntax analysis in the speech processor, and then to processing of accents and intonation in the phoneme processor. Through this processing, information such as a phoneme symbol string, a pitch and a phoneme duration is output. In the final stage, the speech synthesis section synthesizes a speech signal from information such as a phoneme symbol string, a pitch and phoneme duration. Thus, the speech synthesis method for use in the text-to-speech synthesis is required to speech-synthesize a given phoneme symbol string with a given prosody.

According to the operational principle of a speech synthesis apparatus for speech-synthesizing a given phoneme symbol string, basic characteristic parameter units (hereinafter referred to as “synthesis units”) such as CV, CVC and VCV (V=vowel; C=consonant) are stored in a storage and selectively read out. The read-out synthesis units are connected, with their pitches and phoneme durations being controlled, whereby a speech synthesis is performed. Accordingly, the stored synthesis units substantially determine the quality of the synthesized speech. In the prior art, the synthesis units are prepared, based on the skill of persons. In most cases, synthesis units are sifted out from speech signals in a trial-and-error method, which requires a great deal of time and labor.

In some speech synthesis embodiments, labels of the names of phonemes and phonetic contexts are attached to a number of speech segments. The speech segments with the labels are classified into a plurality of clusters relating to the phonetic contexts on the basis of the distance between the speech segments. The centroid of each cluster is used as a synthesis unit. The phonetic context refers to a combination of all factors constituting an environment of the speech segment. The factors are, for example, the name of phoneme of a speech segment, a preceding phoneme, a subsequent phoneme, a further subsequent phoneme, a pitch period, power, the presence/absence of stress, the position from an accent nucleus, the time from a breathing spell, the speed of speech, feeling, etc. The phoneme elements of each phoneme in an actual speech vary, depending on the phonetic context. Thus, if the synthesis unit of each of clusters relating to the phonetic context is stored, a natural speech can be synthesized in consideration of the influence of the phonetic context.

With respect to the software database of embodiments of the present invention, as mentioned previously, a database or other data structure is maintained or accessible that associates particular verbal utterances with corresponding visual elements. For example, the database associates particular verbal utterances of letters, numbers, and/or words with their corresponding textual representations. The database associates particular verbal utterances of the names of shapes with their corresponding graphical shapes. The database associates particular verbal utterances of the names of colors with images of their corresponding visual color.

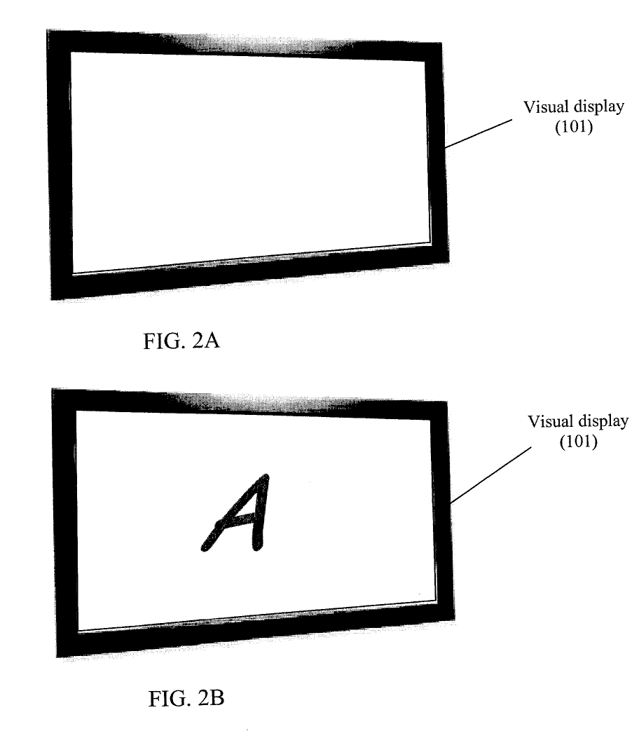

FIG. 2A illustrates a sample blank screen displayed upon the visual display 101 according to at least one embodiment of the present invention. The screen is shown as an all white field although other embodiments may use an all black field or other color or color(s) field. In fact, any background image may be used so long as that when a prominent letter, number, word, color, or shape is displayed prominently upon the image it appears clearly distinguishable form the background image itself. A blank field of all white or all black are the simplest such embodiments. FIG. 2B illustrates the letter “A” displayed prominently upon the all white field background image upon the visual display 101 according to at least one embodiment of the invention. As shown, the letter A is displayed in a prominent and unambiguous manner.

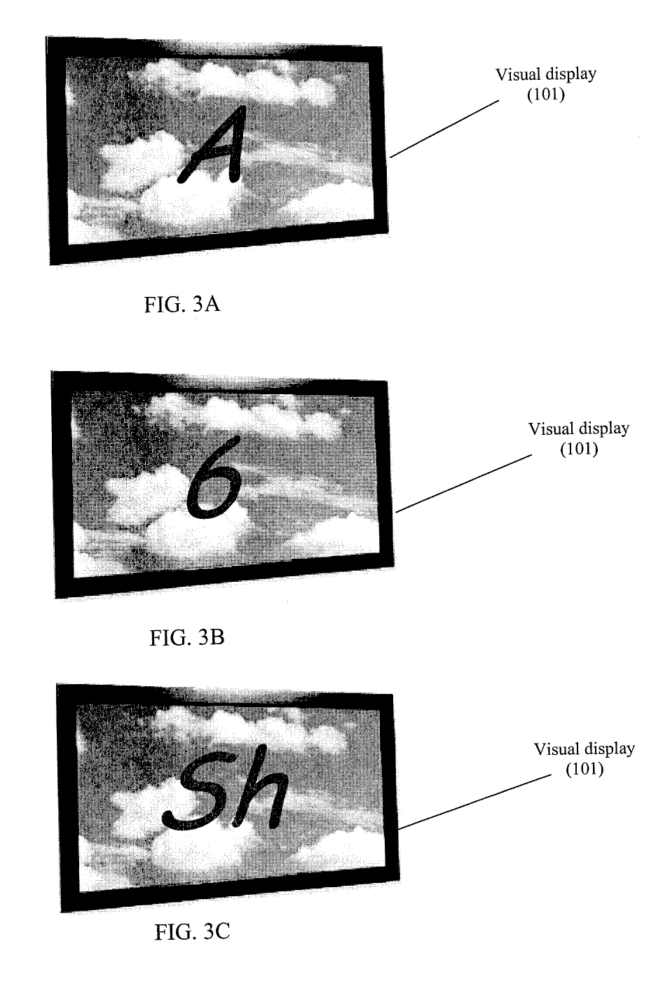

FIG. 3A illustrates a sample display screen shown on the visual display produced in response to the user saying “A” according to at least one embodiment of the invention. As shown, see the same letter A is displayed upon a background image of clouds. Again the letter A is displayed in a prominently and unambiguous manner upon the background image.

Referring back to FIG. 2A and FIG. 2B, two screen shots produced at different moments in time by the software routines of embodiments of the present invention. FIG. 2A shows an image prior to the user making a verbal utterance. The user is, for example, standing in front of the screen at that point in time. Then the user utters the verbal name of the letter A. The user's verbal utterance is captured by the microphone. The audio signal is digitized and stored as a digital audio data by the speech capture routines of the present invention. The digital audio data is then processed by the speech recognition routines. The speech recognition routines determine that the user uttered the verbal name of the letter A. In response to the identified verbal utterance of the name of the letter A, the visual display routines of the present invention select the visual textual representation of the letter A. This is performed by use of a look-up table or other data storage method by which particular verbal utterances are associated in memory with particular visual textural representations. The visual textual representation of the letter A is then displayed to the user as shown in FIG. 2B. An important aspect is that the letter A is displayed in close time-proximity to the time when the user uttered the name of the letter A. By close time-proximity it is meant that a short enough time delay exists between the utterance of the letter A and the visual display of the letter A that they are unambiguously associated by the perception of the user. Also, by close time-proximity it is meant that no intervening images are displayed upon the screen between the time when the user utters the name of the letter A and the time when the letter A is visually displayed which could confuse the user as to the association between the utterance and the correct visual symbol. Thus by having a short enough time delay and no intervening images that could be confused by the user, the display of the letter A is associated by the user with his or her just previous utterance. Another aspect of embodiments of the present invention is that the letter A is displayed in a visually prominent manner as compared to other objects displayed upon the screen. This too is directed at ensuring that the user can unambiguously associate his or her most recent verbal utterance to the prominent image currently displayed.

Referring again to FIG. 3A, an alternate display of the letter A is shown. In this example the letter A is not the ONLY image displayed upon the screen, for the background includes images of a sky and clouds. That said, the letter A is again displayed in a prominent and unambiguous manner. FIGS. 3B and 3C illustrate different example display screens produced by the letter-teaching and number-teaching methods and apparatus according to at least one embodiment of the present invention.

The first example as shown in FIG. 3A is the image displayed by the visual display routines in response to the user uttering the name of the letter “A,” the utterance determined by the speech recognition routines. As shown, a textual image of the letter A is displayed prominently upon a background image. The image is displayed in close time-proximity to the time when the user produced the utterance. Because of the visual prominence of the displayed letter A and the time-proximity with the user's utterance, the user is given an unambiguous indication that the displayed letter corresponds with his or her verbal utterance. The second example as shown in FIG. 3B is the image displayed by the visual display routines in response to the user uttering the name of the number “6,” and the utterance is determined by the speech recognition routines. As shown, a textual image of the number 6 is displayed prominently upon a background image. The image is displayed in close time-proximity to the time when the user produced the utterance. Because of the visual prominence of the displayed number 6 and the time-proximity with the user's utterance, the user is given an unambiguous indication that the displayed number corresponds with his or her verbal utterance. The third example as shown in FIG. 3C is the image visual display routines of the present invention in response to the user uttering the sound produced by the letter combination “sh,” where the utterance is determined by the speech recognition routines. As shown, a textual image of the letter-pair SH is displayed prominently upon a background image. The image is displayed in close time-proximity to the time when the user produced the utterance. Because of the visual prominence of the displayed letter pair A and the time-proximity with the user's utterance the user is given an unambiguous indication that the displayed letter-pair corresponds with his or her verbal utterance.

In some number visualization embodiments of the present invention, additional or alternative visual imagery may be presented to the user in response to the utterance of a particular number. More specifically, in some number visualization embodiments of the present invention, a set of objects may be visually presented to the user in response to his or her utterance of the name of a number, the set of objects including the same number of items as the verbal number uttered by the user. Thus, if a user utters the name of the number 5, a visual image will be presented to the user that depicts five objects, for example five rubber balls. In this way a child may more easily relate the verbal utterance of a number to a number of objects within the real world. The set of objects may be presented alone, or in visual combination with a textual representation of the number.

In some letter visualization embodiments of the present invention, additional or alternative visual imagery may be presented to the user in response to the utterance of the name of a particular letter. More specifically, in some letter visualization embodiments of the present invention, a visual depiction of a familiar object may be visually presented to the user in response to his or her utterance of the name of a letter, the familiar object being such that its name begins within the same letter that was verbally uttered by the user. Thus if a user utters the name of the letter “k,” a visual image of a kite may be presented to the user because the familiar object of a kite begins with the letter “k.” Similarly, if a user utters the name of the letter “q,” a visual image of a queen may be presented to the user because the familiar object of a queen begins with the letter “q.”

In this way a child may more easily relate the verbal utterance of a letter to the names of familiar objects that begin with that letter. The familiar object may be presented alone, or in visual combination with a textual representation of the uttered letter.

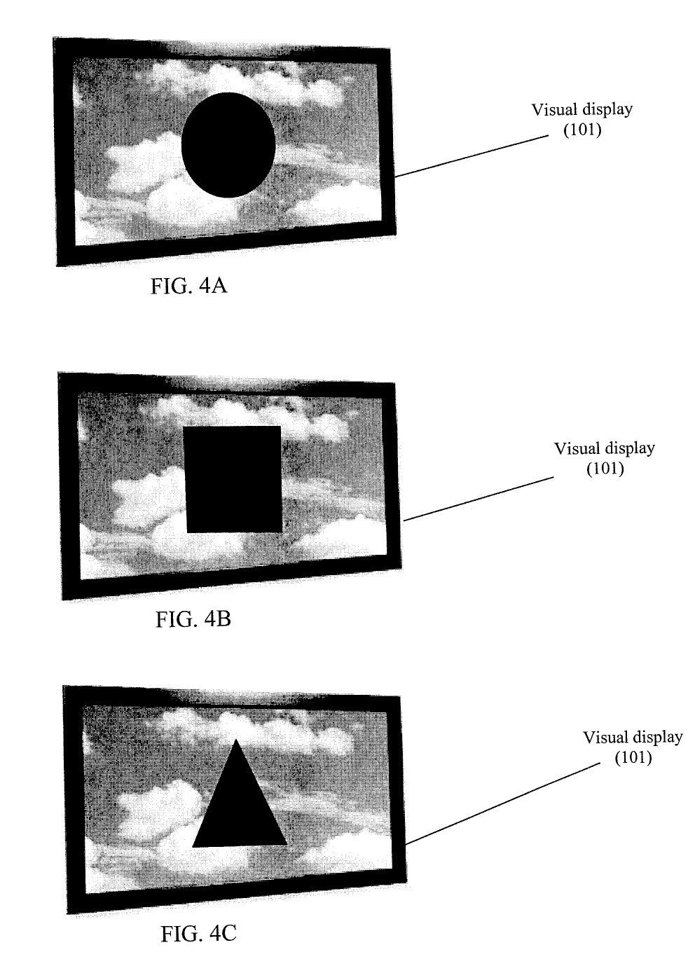

FIGS. 4A-4C illustrates display screens showing shape-teaching methods according to at least one embodiment of the invention. The first example as shown in FIG. 4A is the image displayed by the visual display routines in response to the user uttering “circle” the utterance determined by the speech recognition routines of the present invention. As shown, a graphical image of a circle displayed prominently upon a background image. The image is displayed in close time-proximity to the time when the user produced the utterance. Because of the visual prominence of the displayed circle and the time-proximity with the user's utterance, the user is given an unambiguous indication that the displayed circle corresponds with his or her verbal utterance. The second example as shown in FIG. 4B is the image displayed by the visual display routines of the present invention in response to the user uttering “square,” and the utterance is determined by the speech recognition routines. As shown, a graphical image of a square is displayed prominently upon a background image. The image is displayed in close time-proximity to the time when the user produced the utterance. Because of the visual prominence of the displayed square and the time-proximity with the user's utterance, the user is given an unambiguous indication that the displayed square corresponds with his or her verbal utterance. The third example is shown in FIG. 4C of the result of the image visual display routines in response to the user uttering “triangle,” where the utterance is determined by the speech recognition routines. As shown, a graphical image of a triangle displayed prominently upon a background image. The image is displayed in close time-proximity to the time when the user produced the utterance. Because of the visual prominence of the displayed triangle and the time-proximity with the user's utterance the user is given an unambiguous indication that the displayed triangle corresponds with his or her verbal utterance.

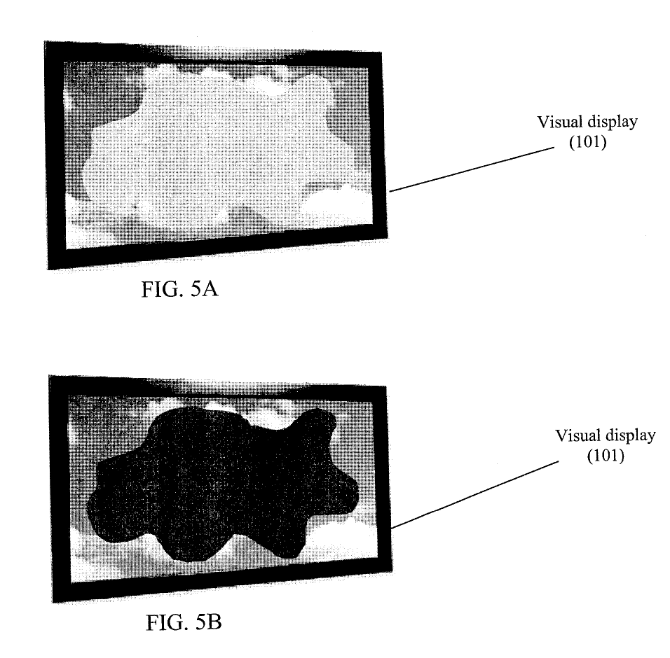

FIGS. 5A and 5B illustrate example display screens produced by the color-teaching methods and apparatus according to at least one embodiment of the invention. The first example as shown in FIG. 5A is the image displayed by the visual display routines in response to the user uttering “green” the utterance determined by the speech recognition routines. As shown, a graphical image of a green area is displayed prominently upon a background image. The image is displayed in close time-proximity to the time when the user produced the utterance. Because of the visual prominence of the displayed green area and the time-proximity with the user's utterance, the user is given an unambiguous indication that the displayed green area corresponds with his or her verbal utterance. The second example as shown in FIG. 5B is the image displayed by the visual display routines of the present invention in response to the user uttering “red,” the utterance determined by the speech recognition routines. As shown, a graphical image of a red area is displayed prominently upon a background image. The image is displayed in close time-proximity to the time when the user produced the utterance. Because of the visual prominence of the displayed red area and the time-proximity with the user's utterance, the user is given an unambiguous perceptual indication that the displayed red area corresponds with his or her verbal utterance.

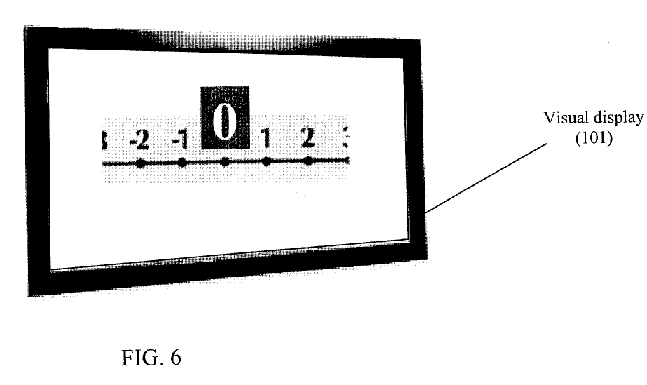

FIG. 6 illustrates a sample display screen produced by a number-teaching method according to at least one embodiment of the invention. More specifically, FIG. 6 shows a sample display screen produced by a “number line embodiment” of the present invention such that the number uttered by the user is displayed prominently upon the screen along with a graphically displayed number line that provides context for the user. As described previously, such embodiments of the present invention include display software routines such that when a user utters a particular number, as determined by the speech recognition routines of the present invention, the uttered number is displayed prominently upon the screen, the uttered number being present along with other numbers on a graphical number line. The uttered number is presented more prominently than the other numbers on the number line by virtual of being larger, brighter, more bold, and/or more centrally located. As shown, an image of the number line is displayed by the visual display routines of the present invention in response to the user uttering “zero,” the user's utterance being determined by the speech recognition routines of the present invention. The graphical image of a number line is produced such that the uttered number “0” is displayed most prominently upon the screen by virtue of being larger, brighter, a different color, and most centrally located as compared to the other numbers on the number line. This image is displayed in close time-proximity to the time when the user produced the utterance. Because of the visual prominence of the displayed “0” on the number line and the time-proximity with the user's utterance, the user is given an unambiguous indication that the displayed “0” corresponds with his or her verbal utterance.

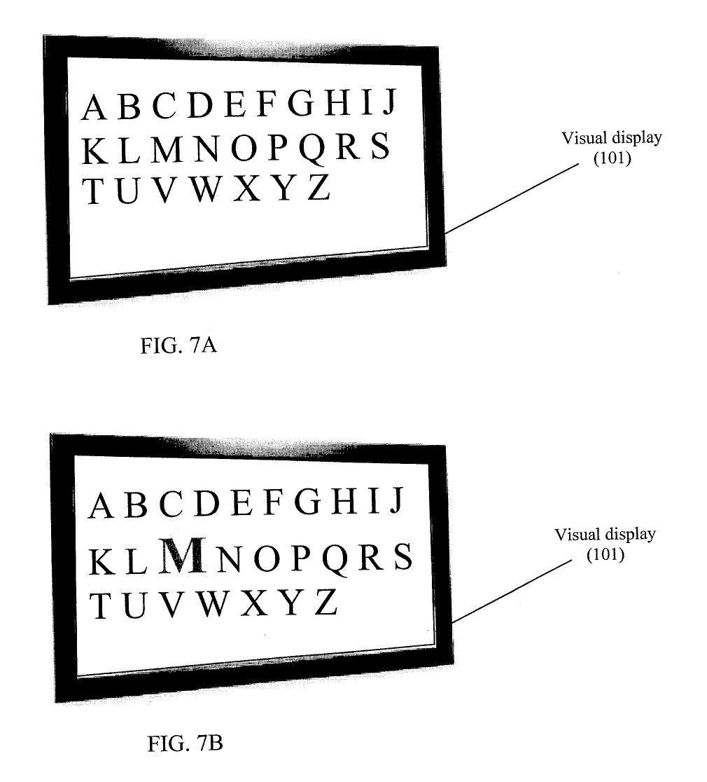

FIGS. 7A and 7B illustrate sample display screens produced by a letter-teaching method according to at least one embodiment of the invention. More specifically, the displays are configured such that a complete alphabet is presented to the user, the alphabet including all the letters A through Z. Referred to herein as a “Alphabet Embodiment” of the present invention, the software is configured such that when a user utters the name and/or sound of a particular letter, that letter in the displayed alphabet is caused to become more visually prominent than the other displayed letters in the alphabet. For example, FIG. 7A shows an example alphabet produced by the display routines of the current invention prior to an utterance by the user. A user of the system then utters the name of a letter or the sound that a letter makes. The utterance is then captured by the speech capture routines of the present invention. The captured utterance is then processed by the speech recognition routines of the present invention. The letter uttered by the user is thereby determined. For example, the user utters the name of the letter “M,” the utterance captured by the speech capture routines. The utterance is then processed as digital data by the speech recognition routines of the present invention. Upon determination that the user uttered the name of the letter M, the visual display routines of the present invention modify the display screen from that shown in FIG. 7A to that shown in FIG. 7B. As shown in FIG. 7B, the image is modified such that the letter M in the displayed alphabet is made to be more visually prominent than the other displayed letter. As shown, the letter M is drawn larger, brighter, in a different color, and in a bolder font, than the other displayed letter in the alphabet. This change in image from that shown in FIG. 7A to that shown in FIG. 7B occurs in close time-proximity to the user's utterance of the letter “M.” Because of the visual prominence of the displayed “M” on screen and the time-proximity with the user's utterance, the user is given an unambiguous indication that the displayed “M” corresponds with his or her verbal utterance.

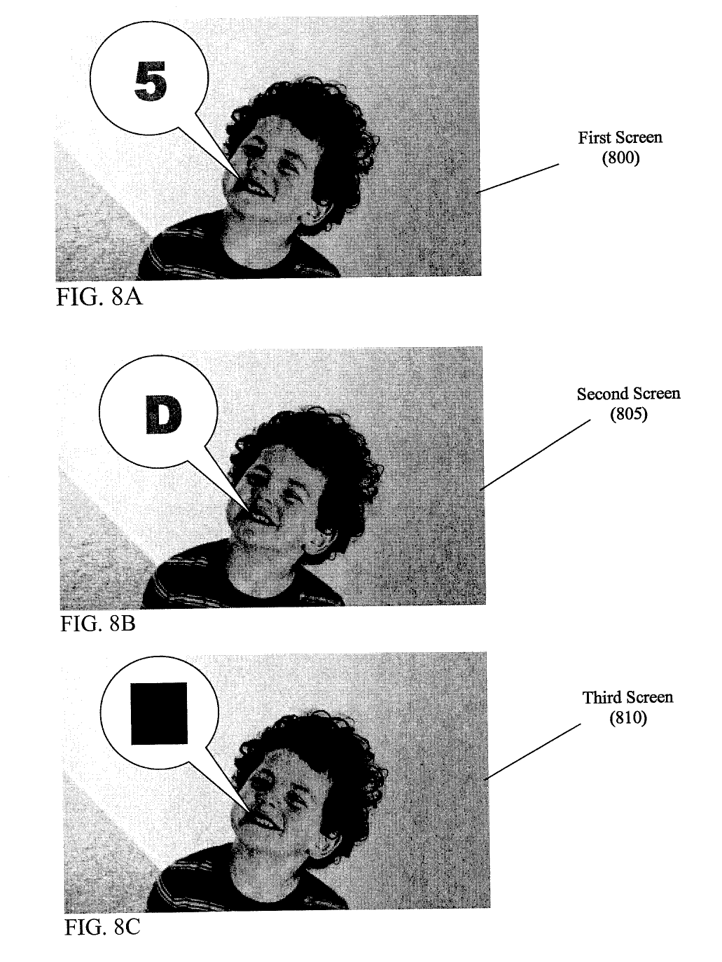

FIGS. 8A-8C illustrate sample display screens produced by Augmented Digital Mirror embodiments of the present invention. As described previously, augmented digital mirror functions are enabled in some embodiments of the present invention through augmented digital mirror software routines operative on processor 100 as shown in FIG. 1. The augmented digital mirror functions are provided to increase the interest among young children and further accentuate the perceived correlation between verbally spoken words and corresponding visual representations. The augmented digital mirror embodiments employ a digital video camera 105 pointed back at the child or children who are using the system. The configuration of the camera and screen are such that camera captures the faces of the child or children who are using the system as they watch the images displayed upon display screen 101. The images captured by the camera are displayed in real-time upon the visual display 101. In this way, the child or children who view the display screen see their own faces presented before them. This creates the visual impression of looking in a mirror as the child looks at the display screen 101.

The augmented digital mirror software according to embodiments of the present invention is thus operative to receive live video image data from camera 105 and display the resulting image stream upon display screen 101 with minimal time delay. In this way as the child is provided the ability to see himself or he uses the system. This self-viewing functionality increases the interactivity of the interface, attracting the attention of young children who are often enthralled by opportunities to watch themselves. The self-viewing functionality also increases the educational benefit of the interface for it encourages the young children to concentrate upon the verbal utterances that they produce for they are given the ability to watch their own faces as they utter the words.

In addition to the digital mirror functionality described above, the augmented digital mirror technology of an embodiment of the current invention enables graphical overlays to augment the displayed image and further increase the educational benefit. More specifically, the augmented digital mirror software is further operative to display graphical overlays upon the image data collected by camera 105, the graphical overlays containing images representative of the letter, number, shape, color, or word most recently uttered by the user. In this way, when a child speaks a letter, number, color, shape, or word, the visual display of that letter, number, color, shape, or word, is presented graphically as an image overlaid upon the image data from camera 105. In some highly effective embodiments, the graphical overlay is presented as a “word balloon” that appears to come from the general direction of the child. In some advanced embodiments the word balloon is overlaid to appear to come specifically from the child's mouth. Such advanced embodiments require image processing routines that determine the general location of the child's mouth within the image data. This is generally performed by detecting the shape of the child's head and then extrapolating the location of the mouth based upon the known placement of mouths with respect to heads. The specifics of image recognition methods for detecting facial features are known to the art and will not be described in detail herein. For example, issued U.S. Pat. No. 6,108,437, the disclosure of which is hereby incorporated by reference, discloses methods and an apparatus by which a human face can be detected within a video image and the location of the face within the image-space can be registered. Using such techniques, the methods according to embodiments of the present invention can display the overlaid graphical word-balloon in a location near to the user's face within the video image. The referenced '473 patent also discloses methods by which particular human facial features can be detected and registered within a video image. Using such techniques, the methods according to embodiments of the present invention can display the overlaid graphical word-balloon in an appropriate location with respect to the user's mouth as shown by example in FIGS. 8A, 8B, and 8C. In addition, U.S. Pat. No. 5,835,616, the disclosure of which is hereby incorporated by reference, discloses additional methods and apparatus by which a human face can be detected and registered within a digital image and specific facial features can be located.

Thus the augmented digital mirror software according to embodiments of the current invention is operative to display an overlaid graphical word balloon upon the real-time image data captured from camera 105 such that the word balloon appears to come from the child in the image. Within the word balloon itself, the letter, number, shape, color, or word that the child has most recently uttered is displayed. In this way the child is provided with a comic book like image that conveys a visual representation of the letter, number, shape, color, or word most recently uttered by the child. As with the other embodiments described herein, the visual display of the letter, number, shape, color, or word (now in an overlaid graphical word balloon) is displayed in close time-proximity to the user utterance thereby conveying a perceptual connection between. Also, as with the other embodiments described herein, the visual display of the letter, number, shape, color, or word (now in an overlaid graphical word balloon) is displayed prominently upon the screen.

For example, a user of an embodiment of the present invention enabled with augmented digital mirror functionality faces display screen 101 such that his or her face is captured in real-time by camera 105. The real-time video image of the users face is displayed upon screen 101 such that the user is looking upon his or her own image. The user then utters the name of number “5,” his or her voice captured by microphone 102. The voice data from the microphone is processed by software running on processor 100. The speech recognition routines of the present invention determine that the child uttered the name of the number “5.” In response, the image display software of the present invention displays a graphical overlay upon the real-time video image of the user, the graphical overlay including a word bubble. Inside the word bubble is the single number “5” prominently displayed. An example image displayed to the user for such a scenario is shown in the first screen 800 FIG. 8A. As shown the image includes the real-time video footage captured of the child with the graphical overlay of the word balloon. Inside the word balloon is a prominent image “5.” It should be noted that the word balloon with included “5” is presented in close time-proximity to the time when the user uttered the word “5.” By close time-proximity it is meant that a short enough time delay exists between the utterance of the number 5 and the visual display of the number 5 that they are unambiguously associated by the perception of the user. Also, by close time-proximity it is meant that no intervening overlaid graphical images are displayed upon the screen between the time when the user utters “5” and the time when 5 is visually displayed that could confuse the user as to the association between the utterance and the correct visual symbol. In other words, some other symbol such as an A or 9 is not displayed during the intervening time interval that could confuse the user as to the association. Thus by having a short enough time delay and no intervening images that could be confused by the user, the display of the number 5 within the balloon is associated by the user with his or her just previous utterance.

Another example image is displayed in the second screen 810 shown in FIG. 8B that corresponds to an augmented digital mirror embodiment of the present invention. This image corresponds to letter-learning scenario in which the user just uttered the name of the letter “D.” As shown in the figure, the displayed image includes the real-time video footage captured of the child with the graphical overlay of the word balloon. Inside the word balloon is a prominent image of a letter “D.” It should be noted that the word balloon with included “D” is presented in close time-proximity to the time when the user uttered “D.”

Another example image is displayed in the third screen 810 shown in FIG. 8C that corresponds to an augmented digital mirror embodiment of the present invention. This image corresponds to shape-learning scenario in which the user just uttered the name of the shape “square.” As shown in the figure, the displayed image includes the real-time video footage captured of the child with the graphical overlay of the word balloon. Inside the word balloon is a prominent image of a graphical square. It should be noted that the word balloon with included graphical square is presented in close time-proximity to the time when the user uttered the word “square.”

By overlaying a graphical balloon upon the real-time image of the child a short time delay after the child utters the particular letter, number, color, shape, or word, the augmented digital mirror embodiments provides a clear, compelling, and unambiguous means of associating specific verbally spoken words from a learner with a specific corresponding visual representation, thereby supporting the learning process. In some embodiments that employ the augmented digital mirror functionality, audio echo functionality (as described previously) is also employed. In such embodiments that support augmented digital mirror functionality and audio echo functionality, the graphical word balloon is presented to the user, overlaid upon his or her digital mirror image, at the same time or nearly the same time as a computer generated verbal utterance of the particular letter, number, color, shape, or word is played through speakers 103. This may be performed using one or more of the speech generation techniques described previously.

The various embodiments discussed above often describe the portable computing device of the present invention as a handheld device such as a PDA, cell phone, or portable media player. While such embodiments are highly effective implementations, a range of other physical embodiments may also be constructed that employ the present invention. For example, a wrist worn embodiment of the present invention may be employed.

Other embodiments, combinations and modifications of this invention will occur readily to those of ordinary skill in the art in view of these teachings. Therefore, this invention is not to be limited to the specific embodiments described or the specific figures provided.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. An educational verbal-visualization system, comprising:
a microphone for capturing verbal utterances from a user;
a display for displaying visual images to the user;
a speaker for playing verbal articulations to the user;
a memory for storing the visual images and the verbal articulations;
a processor in communication with the microphone, display, memory, and speaker, wherein the processor performs verbal-visualization routines comprising:
analyzing the captured verbal utterances from the user;
determining whether one of a plurality of select verbal utterances has been issued by the user and, in response to a successful determination, identifying a particular select verbal utterance issued;
selecting from the memory a stored visual image that relationally corresponds with the identified particular select verbal utterance;
causing a prominent display of the stored visual image to the user within a close time proximity of issuance of the particular select verbal utterance; and
accessing from the memory a stored verbal articulation that mimics the particular select verbal utterance and causing the stored verbal articulation to be played through the speaker a short time delay after the issuance of the particular select verbal utterance, the short time delay being selected such that the played verbal articulation presents an echo effect of the select verbal utterance of the user.

2. The system of claim 1 wherein at least a portion of the plurality of select verbal utterances corresponds to names of letters in an alphabet, and wherein a visual image selected from the memory, in response to the utterance of the name of a particular letter in the alphabet, visually depicts the particular letter in the alphabet.

3. The system of claim 1 wherein at least a portion of the plurality of select verbal utterances corresponds to names of numbers and wherein a visual image selected from the memory in response to the utterance of the name of a particular number visually depicts the particular number.

4. The system of claim 1 wherein at least a portion of the plurality of select verbal utterances corresponds to names of shapes and wherein a visual image selected from the memory in response to the utterance of the name of a particular shape visually depicts the particular shape.

5. The system of claim 1 wherein at least a portion of the plurality of select verbal utterances corresponds to names of colors and wherein a visual image selected from the memory in response to the utterance of the name of a particular color visually depicts the particular color.

6. The system of claim 2 wherein two separate verbal utterances are associated with each letter in the alphabet, one utterance corresponding to an uppercase version of the particular letter and a second utterance corresponding to a lowercase version of the particular letter.

7. The system of claim 6 wherein the visual image selected from the memory in response to the utterance associated with the uppercase version of the particular letter visually depicts the uppercase version of the particular letter, and wherein the visual image selected from the memory in response to the utterance associated with the lowercase version of the particular letter visually depicts the lowercase version of the particular letter.

8. The system of claim 1 wherein the stored verbal articulation corresponding to the particular select verbal utterance is a pre-stored verbal representation of the particular select verbal utterance.

9. The system of claim 1 wherein the stored verbal articulation corresponding to the particular select verbal utterance is digitized sample of the user issuing the particular select verbal utterance.

10. The system of claim 1 wherein the verbal-visualization routines are adapted to display a number line upon the display and in response to a select verbal utterance corresponding to a particular number on the number line, cause the particular number to be more prominently displayed than other numbers on the number line.

11. The system of claim 1 wherein the verbal-visualization routines are adapted to display a full alphabet visually upon the display and in response to a select verbal utterance corresponding to a particular letter in the alphabet, cause the particular letter to be more prominently displayed than other letters in the alphabet.

12. The system of claim 1 further comprising a video camera to capture an image of the user and feed the image of the user to the processor, the verbal-visualization routines being further adapted to display the image of the user on the display simultaneously with the display of a visual image selected in response to a select verbal utterance of the user.

13. The system of claim 12 wherein a simulated message balloon is presented on the display simultaneously with and in proximal relation to the image of the user, and the visual image is displayed according to at least one of: within the simulated message balloon, and upon the simulated message balloon.

14. The system of claim 1 wherein the accessed verbal articulation that corresponds with the particular select verbal utterance is one of a pre-stored verbal representation of the particular select verbal utterance and a digitized sample of the user issuing the particular select verbal utterance.

15. A method for educational verbal-visualization, comprising:
analyzing an electronically captured verbal utterance from a user;
determining whether the captured verbal utterance corresponds to one of a plurality of select verbal utterances and, in response to a successful determination, identifying a particular select verbal utterance issued by the user;
selecting from a memory a stored visual image relationally corresponding to the identified particular select verbal utterance;
causing a prominent visual presentation of the selected visual image to be displayed upon an electronic display, the prominent visual presentation being imparted within a close time proximity of issuance of the particular select verbal utterance by the user; and
accessing from the memory a stored verbal articulation that mimics the particular select verbal utterance and causing the stored verbal articulation to be played through the speaker a short time delay after the issuance of the particular select verbal utterance, the short time delay being selected such that the played verbal articulation presents an echo effect of the select verbal utterance of the user.

16. The method of claim 15 wherein the particular select verbal utterance is a name of a letter of an alphabet and wherein a visual image displayed in response to the utterance visually depicts the letter of the alphabet.

17. The method of claim 16 wherein the selected visual image displayed comprises a depiction of a familiar object, the name of the familiar object beginning with the letter corresponding to the name of the letter uttered by the user.

18. The method of claim 15 wherein the particular select verbal utterance is the name of a number and wherein the visual image displayed in response to the utterance visually depicts the number.

19. The method of claim 18 wherein the selected visual image displayed comprises a depiction of a number of objects, the number of objects corresponding to the number uttered by the user.

20. The method of claim 15 wherein the particular select verbal utterance is a name of a shape or color and wherein the visual image displayed in response to the utterance visually depicts the shape or color.

21. A method for educational verbal-visualization, comprising:
defining in a computer memory a set of select verbal utterances, the set of select verbal utterances comprising names of letters in an alphabet, names of numbers, names of shapes, and the names of colors;
analyzing an electronically captured verbal utterance from a user;
determining whether the captured verbal utterance corresponds to one of the set of select verbal utterances defined in the computer memory and, in response to a successful determining, identifying a particular one of the select verbal utterances that was issued by the user;
selecting from the memory a stored visual image that relationally corresponds to the identified particular one of the select verbal utterances, the stored visual image depicting at least one of a textual letter, textual number, graphical shape, and graphical color that directly corresponds to the identified particular select verbal utterance; and
causing a prominent visual presentation of the selected visual image to be displayed upon an electronic display, the prominent visual presentation being imparted within a close time proximity of issuance of the particular select verbal utterance by the user.

22. The method of claim 21 wherein a number line is visually presented upon the electronic display and wherein a particular number on the number line is displayed more prominently than other numbers, the particular number corresponding to a most recently issued verbal utterance of the user.

23. The method of claim 21 wherein a textual alphabet is visually presented upon the electronic display and wherein a particular letter in the alphabet is displayed more prominently than other letters, the particular letter corresponding to a most recently issued verbal utterance of the user.

24. The method of claim 21 wherein the particular select verbal utterance is a name of a letter of the alphabet and wherein the visual image displayed in response to the utterance visually depicts the letter of the alphabet.

25. The method of claim 24 wherein the selected visual image presented upon the display includes a depiction of a familiar object, a name of the familiar object beginning with the letter that corresponds to a name of the letter uttered by the user.

26. The method of claim 21 wherein the particular select verbal utterance is a name of a shape or color and wherein the visual image displayed in response to the utterance visually depicts the shape or color.
